(19) United States
(12) Patent Application Publication
(10) Pub. No.: US 2021/0181887 A1
(43) Pub. Date: Jun. 17, 2021

(54) INPUT DEVICE AND OPERATION METHOD THEREOF

(71) Applicants: HYUNDAI MOTOR COMPANY, Seoul (KR); KIA MOTORS CORPORATION, Seoul (KR)

(72) Inventors: Ok Kun Cha, Seoul (KR); Sang Min Moon, Seoul (KR); Jin Woo Tak, Seoul (KR)

(21) Appl. No.: 16/998,586

(22) Filed: Aug. 20, 2020

(30) Foreign Application Priority Data
Dec. 13, 2019 (KR) 10-2019-0167079

(51) Int. Cl. G06F 3/041; G06F 3/02; G06F 3/0488; G06F 3/0485

(52) U.S. Cl. CPC G06F 3/0416; G06F 3/0485; G06F 3/04883; G06F 3/0202

(57) ABSTRACT

An input device is provided. The input device includes a touch display that recognizes an input of a user and a controller that recognizes at least any one of touch coordinates and/or gesture pattern information from the input of the user and deforms a shape of the touch display depending on the at least any one of the touch coordinates and/or the gesture pattern information to form a deformable manipulation part having a different user setting function.

### CROSS REFERENCE TO RELATED APPLICATIONS

This application is claims the benefit of priority to Korean Patent Application No. 10-2019-0167079, filed in the Korean Intellectual Property Office on Dec. 13, 2019, the entire contents of which are incorporated herein by reference.

### TECHNICAL FIELD

The present disclosure relates to an input device and an operation method thereof.

### BACKGROUND

Unlike a typical display used to display images in a mobile device or the like, a shape display refers to a display device which physically deforms a unit of a display surface to represent information.

Recently, in the field of such a shape display, a deformable display using a linear cam, a dynamic display system, which three-dimensionally deforms an elastic surface by a mechanical actuator array (a pneumatic piston, a connection node, or the like) provided in a lower portion of a screen, or the like, has been introduced.

However, a touch display or the like, which performs a function of representing a touch input of a user and a plurality of pixels as color information, is not provided on an upper end of a general shape display, and there is a limitation that the same input manner and function is only provided irrespective of a form where the display surface is deformed.

### SUMMARY

The present disclosure has been made to solve the above-mentioned problems occurring in the prior art while advantages achieved by the prior art are maintained intact.

An aspect of the present disclosure provides an input device for recognizing at least any one of touch coordinates and/or gesture pattern information depending on an input of the user and providing a deformable manipulation part, a shape of which is changed, to improve convenience of manipulation of the user and a method thereof.

Another aspect of the present disclosure provides an input device for providing deformable manipulation parts of different shapes depending on gesture pattern information to perform a predetermined function depending on a changed shape to provide a sense of physical manipulation incapable of being provided by a two-dimensional display to a user and a method thereof.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an input device may include a touch display that recognizes an input of a user and a controller that recognizes at least any one of touch coordinates and/or gesture pattern information from the input of the user and deforms a shape of the touch display depending on the at least any one of the touch coordinates and the gesture pattern information to form a deformable manipulation part having a different user setting function.

Furthermore, in an embodiment, the controller may control a vertical movement of a deformable member located inside or outside the touch display to form the deformable manipulation part.

Furthermore, in an embodiment, the controller may recognize the gesture pattern information as first gesture pattern information, when there is a touch user input, the touch coordinates of which are discrete, and when the number of touches in the touch user input corresponds to a set number.

Furthermore, the controller may protrude a region corresponding to a location set on a surface of the touch display or a location of touched respective coordinates to form a switch-type deformable manipulation part on the surface of the touch display, when recognizing the first gesture pattern information.

Furthermore, the controller may execute a predetermined function, when a touch input on an upper region of the protruded region is recognized after the region is protruded.

Furthermore, in an embodiment, the controller may recognize the gesture pattern information as second gesture pattern information, when there is a scroll user input, the touch coordinates of which are continuous, and when a length of the scroll user input corresponds to a set length.

Furthermore, the controller may protrude a region corresponding to a location set on a surface of the touch display or corresponding to a straight line where initial touch coordinates are a start point and where final touch coordinates are an end point to form a rod-type deformable manipulation part on the surface of the touch display, when recognizing the second gesture pattern information.

Furthermore, the controller may execute a predetermined function, when a touch input on an upper or side region of the protruded region is recognized after the region is protruded.

Furthermore, in an embodiment, the controller may recognize the gesture pattern information as third gesture pattern information, when there is a swiping user input, the touch coordinates of which include a portion or all of a set closed curve, and when a length of the swiping user input corresponds to a set length.

Furthermore, the controller may protrude a region corresponding to a location set on a surface of the touch display or corresponding to all or a portion of a closed curve including from initial touch coordinates to final touch coordinates to form a circular deformable manipulation part on the surface of the touch display, when recognizing the third gesture pattern information.

Furthermore, the controller may execute a predetermined function, when a touch input on an upper or side region of the protruded region is recognized after the region is protruded.

Furthermore, in an embodiment, the controller may implement a graphic user interface (GUI) according to a form of the deformable manipulation part on the touch display.

Furthermore, in an embodiment, the controller may release the formed deformable manipulation part to return to an original state, when there is no user input on the touch display during a set time.

According to another aspect of the present disclosure, an operation method of an input device may include recognizing an input of a user, recognizing at least any one of touch coordinates and/or gesture pattern information from the input of the user, and deforming a shape of a touch display depending on the at least any one of the touch coordinates and/or the gesture pattern information to form a deformable manipulation part having a different user setting function.

Furthermore, in an embodiment, the forming of the deformable manipulation part may include controlling a vertical movement of a deformable member located inside or outside the touch display to form the deformable manipulation part.

Furthermore, in an embodiment, the recognizing of the at least any one of the touch coordinates and/or the gesture pattern information may include recognizing the gesture pattern information as first gesture pattern information, when there is a touch user input, the touch coordinates of which are discrete, and when the number of touches in the touch user input corresponds to a set number.

Furthermore, the forming of the deformable manipulation part may include protruding a region corresponding to a location set on a surface of the touch display or a location of touched respective coordinates to form a switch-type deformable manipulation part on the surface of the touch display, when recognizing the first gesture pattern information.

Furthermore, in an embodiment, the recognizing of the at least any one of the touch coordinates and/or the gesture pattern information may include recognizing the gesture pattern information as second gesture pattern information, when there is a scroll user input, the touch coordinates of which are continuous, and when a length of the scroll user input corresponds to a set length.

Furthermore, the forming of the deformable manipulation part may include protruding a region corresponding to a location set on a surface of the touch display or corresponding to a straight line where initial touch coordinates are a start point and where final touch coordinates are an end point to form a rod-type deformable manipulation part on the surface of the touch display, when recognizing the second gesture pattern information.

Furthermore, in an embodiment, the recognizing of the at least any one of the touch coordinates and/or the gesture pattern information may include recognizing the gesture pattern information as third gesture pattern information, when there is a swiping user input, the touch coordinates of which include a portion or all of a set closed curve, and when a length of the swiping user input corresponds to a set length.

Furthermore, the forming of the deformable manipulation part may include protruding a region corresponding to a location set on a surface of the touch display or corresponding to all or a portion of a closed curve including from initial touch coordinates to final touch coordinates to form a circular deformable manipulation part on the surface of the touch display, when recognizing the third gesture pattern information.

Furthermore, in an embodiment, the method may further include implementing a graphic user interface (GUI) on the touch display depending on a form of the deformable manipulation part.

Furthermore, in an embodiment, the method may further include releasing the formed deformable manipulation part to return to an original state, when there is no user input on the touch display during a set time.

### BRIEF DESCRIPTION OF THE FIGURES

The above and other objects, features and advantages of the present disclosure will be more apparent from the following detailed description taken in conjunction with the accompanying drawings:

FIG. 1 is a block diagram illustrating an input device according to an embodiment of the present disclosure;

FIG. 2 is a cross-sectional view illustrating an input device according to an embodiment of the present disclosure;

FIG. 3 is a cross-sectional view illustrating an input device in which a deformable member is formed in a touch display, according to another embodiment of the present disclosure;

FIGS. 4A, 4B, and 4C are perspective views illustrating an embodiment of forming a switch-type deformable manipulation part of an input device according to an embodiment of the present disclosure;

FIGS. 5A, 5B, and 5C are perspective views illustrating an embodiment of forming a rod-type deformable manipulation part of an input device according to an embodiment of the present disclosure;

FIGS. 6A, 6B, and 6C are perspective views illustrating an embodiment of forming a circular deformable manipulation part of an input device according to an embodiment of the present disclosure;

FIG. 7 is a perspective view illustrating an embodiment of forming a deformable manipulation part of an input device according to an embodiment of the present disclosure;

FIG. 8 is a perspective view illustrating an embodiment of releasing a formed deformable manipulation part to return to an original state, when there is no user input during a set time, in an operation method of an input device according to an embodiment of the present disclosure;

FIG. 9 is a flowchart illustrating an operation method of an input device according to an embodiment of the present disclosure;

FIG. 10 is a flowchart illustrating a method for recognizing first gesture pattern information and forming a switch-type deformable manipulation part in an operation method of an input device according to an embodiment of the present disclosure;

FIG. 11 is a flowchart illustrating a method for recognizing second gesture pattern information and forming a rod-type deformable manipulation part in an operation method of an input device according to an embodiment of the present disclosure;

FIG. 12 is a flowchart illustrating a method for recognizing third gesture pattern information and forming a circular deformable manipulation part in an operation method of an input device according to an embodiment of the present disclosure;

FIG. 13 is a drawing illustrating graphic user interfaces of switch-type deformable manipulation parts according to an embodiment of the present disclosure;

FIG. 14 is a drawing illustrating graphic user interfaces of switch-type deformable manipulation parts, rod-type deformable manipulation parts, and a circular deformable manipulation part according to an embodiment of the present disclosure;

FIG. 15 is a drawing illustrating a graphic user interface of a circular deformable manipulation part according to another embodiment of the present disclosure; and

FIG. 16 is a drawing illustrating an operation of a user setting function of a deformable manipulation part and a location where an input device is applied according to an embodiment of the present disclosure.

### DETAILED DESCRIPTION

Hereinafter, some embodiments of the present disclosure will be described in detail with reference to the exemplary drawings. The following introduced exemplary embodiments are only provided as examples so that the present disclosure will fully convey the spirit of the present disclosure to those skilled in the art and are not limited to the embodiment provided in the present disclosure. The present disclosure is embodied in another implementation form. The drawing may omit illustrating a portion irrespective of the description for clarifying the present disclosure, and the size and the like of the component are exaggerated and expressed for better understanding.

Furthermore, in adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The present disclosure discloses contents about an input device of a vehicle as an embodiment, but is not necessarily limited to being used in the vehicle. The present disclosure may be used in various input devices, such as a mobile phone, a smartphone, a laptop computer, a digital broadcast terminal, personal digital assistants (PDA), a navigation device, a slate personal computer (PC), a tablet PC, an ultrabook, a wearable device, and a kiosk, each of which has a touch display as a similar input device.

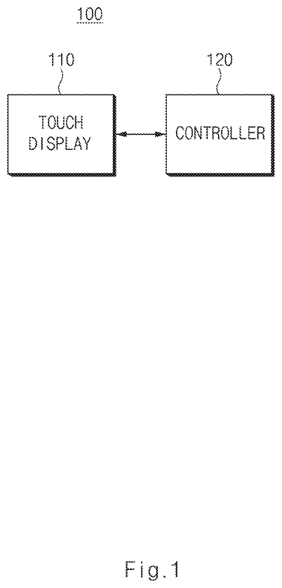

FIG. 1 is a block diagram illustrating an input device according to an embodiment of the present disclosure.

Referring to FIG. 1, an input device 100 may include a touch display 110 and a controller 120.

The touch display 110 may receive an input from a user. Hereinafter, the description assumes that a user input is based on a touch input. The touch display 110 may recognize an input of the user. The controller 120 may recognize at least any one of touch coordinates and/or gesture pattern information from the input of the user. The gesture pattern information may include information about the number of touches.

Herein, the touch coordinates may refer to physical coordinates of a user input received on the touch display 110.

The number of touches may refer to whether there are several contacts on the touch display 110, that is, the number of user inputs (touch inputs).

The gesture pattern information may refer to a pattern profile obtained as the controller 120 analyzes an input of the user on the touch display 100 and recognizes whether the input corresponds to any predetermined pattern. In other words, the gesture touch information may refer to a shape of a user input on the touch display 110.

The gesture touch information may include a touch gesture used for a general touch input device. For example, the input device 100 according to an embodiment of the disclosure may recognize gesture pattern information including any one of a ‘touch user input’ which refers to a discrete input, a ‘scroll user input’ which refers to a continuous input, and/or a ‘swiping user input’ in which a continuous input includes a portion or all of a closed curve. The gesture pattern information may further include information about a touch time other than the number of touches. The touch time may refer to a time when a user input is maintained or the duration of a contact of a user input on the touch display 110.

The controller 120 may recognize the gesture pattern information recognized according to at least any one of the touch coordinates and/or the gesture pattern information as first gesture pattern information, second gesture pattern information, or third gesture pattern information.

When there is a touch user input, touch coordinates of which are discrete, and when the number of touches in the touch user input corresponds to a set number, the controller 120 may recognize gesture pattern information corresponding to it as the first gesture pattern information.

When there is a scroll user input, touch coordinates of which are continuous, and when a length of the scroll user input corresponds to a set length, the controller 120 may recognize gesture touch information corresponding to it as the second gesture pattern information. In this case, the ‘length of the scroll user input’ refers to the entire length in which continuous touch coordinates are connected as one line.

When there is a swiping user input, touch coordinates of which include a portion or all of a set closed curve, and when a length of the swiping user input corresponds to a set length, the controller 120 may recognize gesture pattern information corresponding to it as the third gesture pattern information.

In this case, that ‘the length of the swiping user input corresponds to the set length’ may refer to whether the entire length connecting the touch coordinates of the swiping user input indicates a specified rate or more (e.g., 70% or more) of the entire length of the set closed curve. Alternatively, that ‘the length of the swiping user input corresponds to the set length’ may refer to whether the entire length connecting the touch coordinates of the swiping user input indicates a specified length or more.

Each of the first gesture pattern information, the second gesture pattern information, and the third gesture pattern information may include information about the number of touches. The controller 120 may form a deformable manipulation part depending on the first to third gesture pattern information. Furthermore, each of the first to third gesture pattern information may include a touch time.

The touch display 110 may be a capacitive or resistive touch display. The touch display 110 may recognize a user input and may output a graphic user interface. When it is possible to change a shape of the touch display 110, the touch display 110 is not limited to materials or operation manners.

The controller 120 may control the touch display 110 based on the gesture pattern information recognized from the user input. For example, the controller 120 may deform a shape of the touch display 110 depending on the first to third gesture pattern information to form a deformable manipulation part having a different user setting function.

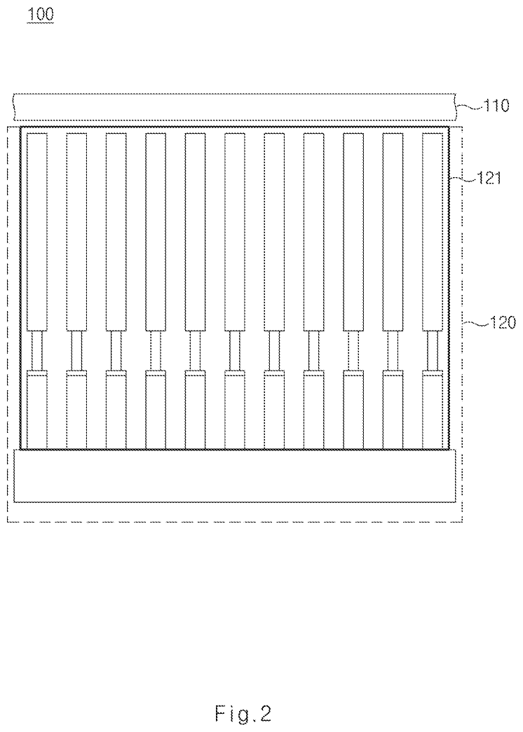

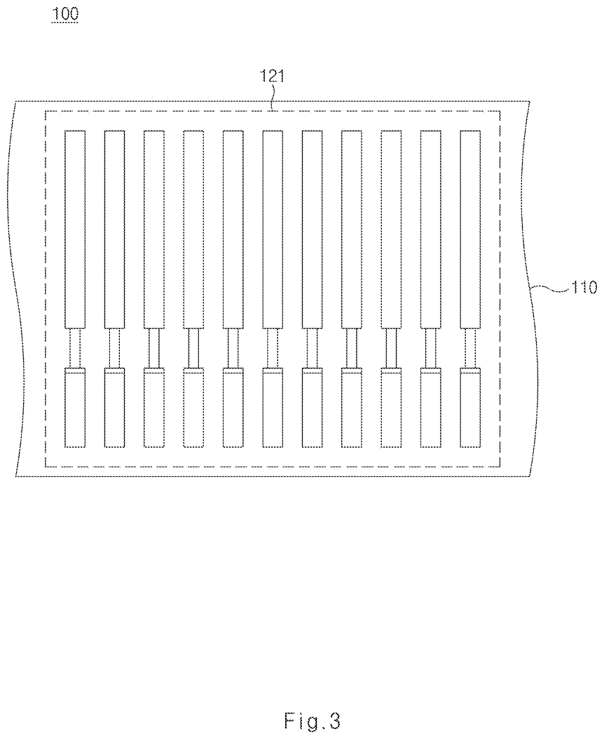

The controller 120 may control a vertical movement of a deformable member located in the touch display 110 depending on the gesture pattern information to form the deformable manipulation part. This will be described in detail below with reference to FIGS. 2 and 3.

When recognizing the first gesture pattern information, the controller 120 may protrude a region corresponding to a location set on a surface of the touch display 110 or a location of touched respective coordinates to form a switch-type deformable manipulation part on the surface of the touch display 110.

In this case, the protruded region may be a region corresponding to touched respective coordinates of the first gesture pattern information depending to a user setting.

The set location may be randomly selected according to a user setting.

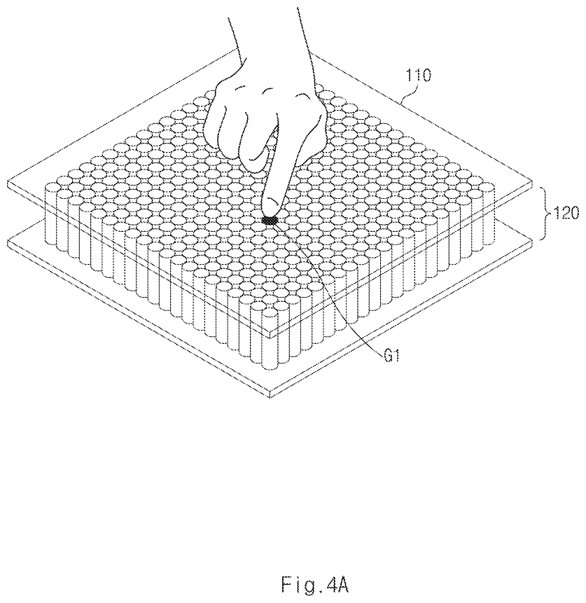

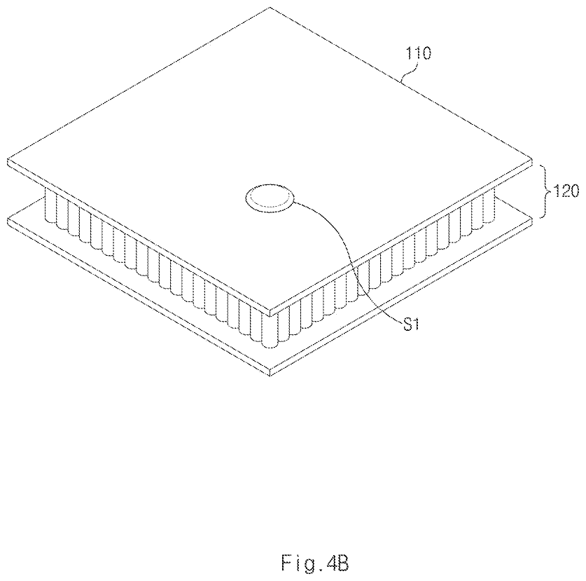

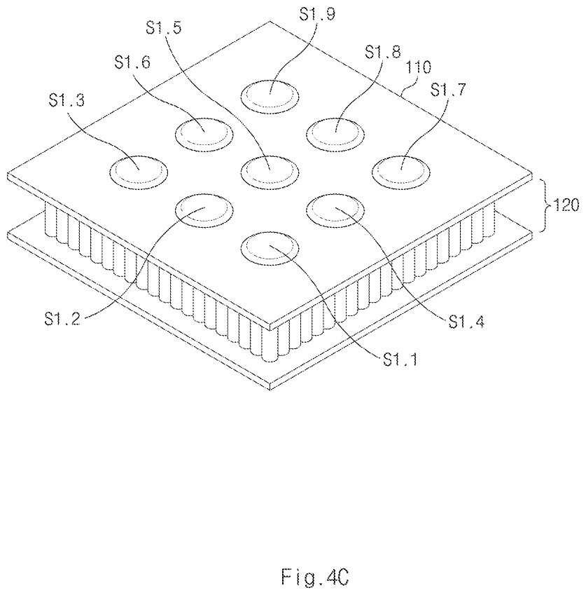

The switch-type deformable manipulation part is not limited in size, location, and form. For example, it is possible for the controller 120 to recognize the first gesture pattern information and protrude a region corresponding to coordinates independent of the touched respective coordinates of the first gesture pattern information. This will be described in detail with reference to FIG. 4C and the like.

When recognizing the second gesture pattern information, the controller 120 may protrude a region corresponding to a location set on the surface of the touch display 110 or corresponding to a straight line where initial touch coordinates are a start point and where final touch coordinates are an end point to form a rod-type deformable manipulation part on the surface of the touch display 110.

In this case, the protruded region may be a region corresponding to touch coordinates of the second gesture pattern information. In this case, the protruded region may be the region corresponding to the straight line where the initial touch coordinates are the start point and where the final touch coordinates are the end point.

The set location may be randomly selected according to a user setting.

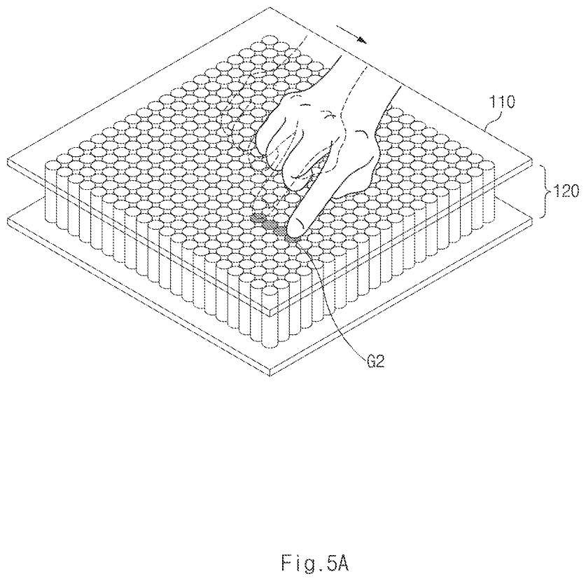

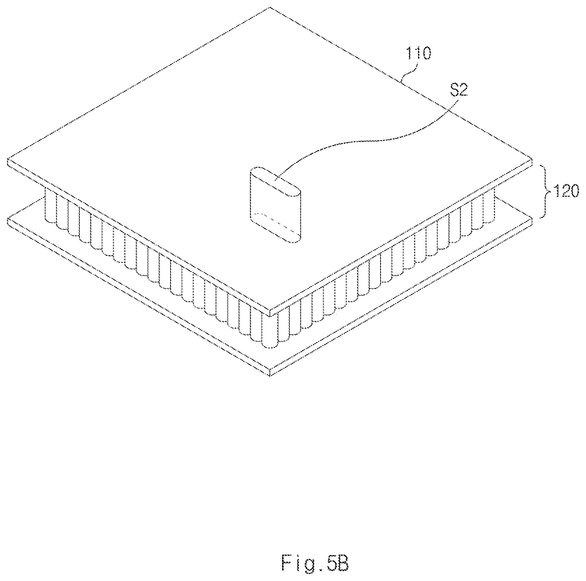

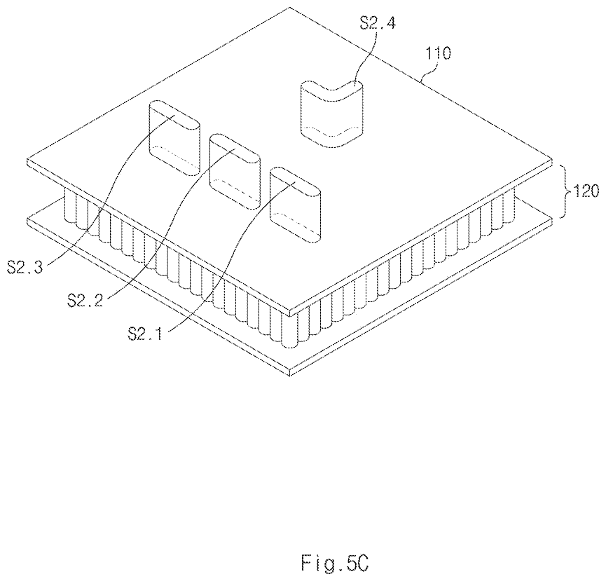

The rod-type deformable manipulation part is not limited in size, location, and form. For example, it is possible for the controller 120 to recognize the second gesture pattern information and protrude a region corresponding to coordinates independent of the touch coordinates of the second gesture pattern information. This will be described in detail with reference to FIG. 5C and the like.

When recognizing the third gesture pattern information, the controller 120 may protrude a region corresponding to a location set on the surface of the touch display 110 or corresponding to all or a portion of a closed curve including from initial touch coordinates to final touch coordinates to form a circular deformable manipulation part on the surface of the touch display 110.

In this case, the protruded region may be a region corresponding to closed curve coordinates of the third gesture pattern information. In other words, the protruded region may be the region corresponding to all or the portion of the closed curve including from the initial touch coordinates to the final touch coordinates.

The set location may be randomly selected according to a user setting.

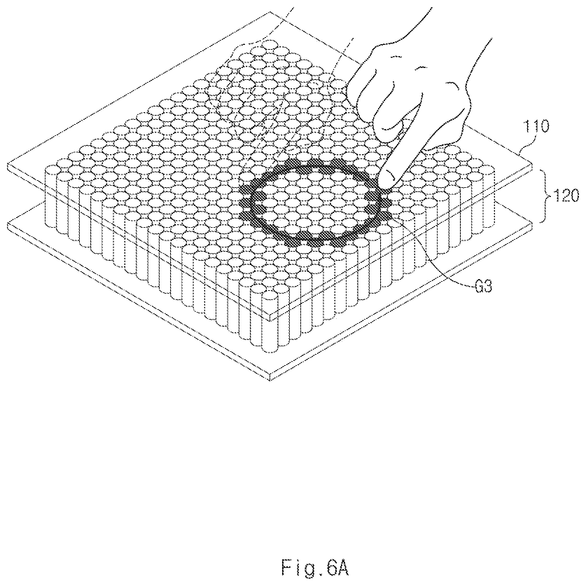

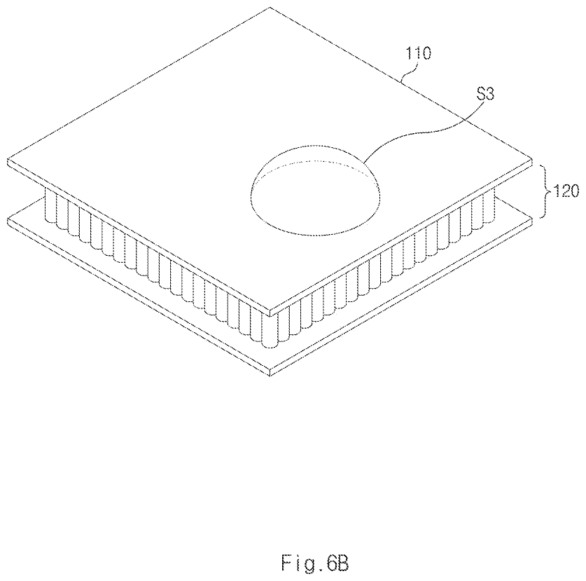

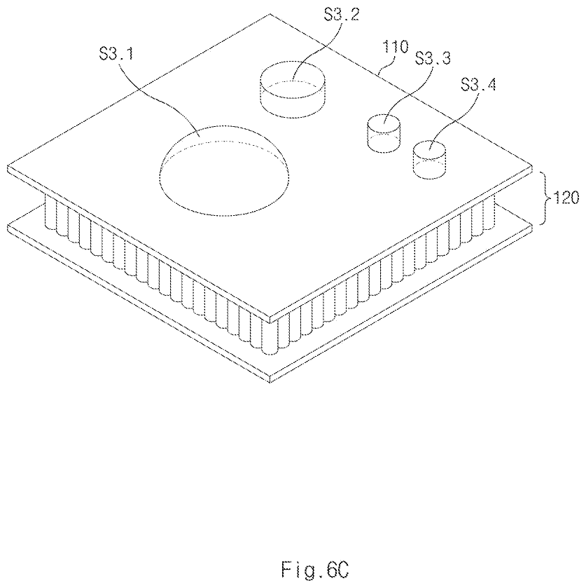

The circular deformable manipulation part is not limited in size, location, and form. For example, it is possible for the controller 120 to recognize the third gesture pattern information and protrude a region corresponding to coordinates independent of the touch coordinates of the third gesture pattern information. This will be described in detail with reference to FIG. 6C and the like.

The controller 120 may form a deformable manipulation part having a different user setting function depending on gesture pattern information. The user setting function may be various functions such as an air conditioning device, an audio, video, navigation (AVN) device, and an internal light device in the vehicle. When the user setting function is a function capable of being performed by the input device 100, it is not limited to the exemplary functions. In other words, the deformable manipulation part may be used as a manipulation button or the like for the user setting function.

As described above, when there is the user input on the touch display 110, the controller 120 may recognize gesture pattern information and may change a surface shape of the touch display 110 to form a deformable manipulation part. As the controller 120 implements a graphic user interface on the surface of the touch display 110 depending on a form of the formed deformable manipulation part, unlike a two-dimensional input device, it is possible for the user to easily perform manipulation in a situation where it is impossible for the user to see a manipulator. Furthermore, because the deformable manipulation part provides a familiar sense of manipulation to the user, user convenience may be increased.

FIG. 2 is a cross-sectional view illustrating an input device according to an embodiment of the present disclosure.

Referring to FIG. 2, a controller 120 may be provided in a lower portion of a touch display 110. Furthermore, the controller 120 may include a deformable member 121.

According to an embodiment shown in FIG. 2, the controller 120 may control the touch display 110 using a separate actuator. Herein, the actuator may refer to an actuator using electricity, oil pressure, compressed air, or the like and may be used as a term which refers to a mechanical device used to move or control a system.

Meanwhile, although not illustrated in the drawing, a controller may be classified as a separate actuator (a control module). In this case, a set of all actuators may be called one controller.

FIG. 3 is a cross-sectional view illustrating an input device according to another embodiment of the present disclosure.

Referring to FIG. 3, a deformable member 121 may be provided in a touch display 110. The deformable member 121 may operate according to an electronic control scheme or a mechanical control scheme, which is necessarily limited to the embodiment.

In FIGS. 2 and 3, the deformable member 121 of a controller 120 may be an actuator. In this case, the controller 120 may control a surface shape of a touch display 110 through contraction and relaxation of the deformable member 121. The deformable member 121 is not necessarily limited to the actuator, and may be selected as any of components capable of deforming the surface shape of the touch display 110. A drive gear may be used as an embodiment of the deformable member 121 or an elastic member such as a spring may be used as an embodiment of the deformable member 121. Furthermore, a pneumatic actuator, an electronic actuator, or the like may be selected as an embodiment of the deformable member 121. Herein, for convenience of understanding, the description assumes that the deformable member 121 is the actuator shown in FIGS. 2 and 3.

FIGS. 4A to 4C are drawings illustrating a process where a controller 120 forms switch-type deformable manipulation parts S1 and S1.1 to S1.9 according to an embodiment of the present disclosure. The switch-type deformable manipulation parts S1 and S1.1 to S1.9 may be formed as, when there is a touch user input on a touch display 110, touch coordinates of which are discrete, and when the number of touches in the touch user input corresponds to a set number, the controller 120 recognizes gesture pattern information according to the touch user input as first gesture pattern information.

The number of touches for recognizing the first gesture pattern information may be randomly set by a user and may be preferably set to 1 to 5 for easy one-hand manipulation while driving.

In FIGS. 4A and 4B, an embodiment in which, when touch coordinates are discrete and when the set number of touches is 1, the controller 120 recognizes the gesture touch information as the first gesture pattern information is shown. Gesture pattern information G1 corresponding to the first gesture pattern information, exemplified in FIG. 4A, may have 1 touch, but may have the any number of touches depending to a user setting.

Referring to FIG. 4B, the controller 120 may protrude a region of the touch display 110 at a location corresponding to touched respective touch coordinates of a user input using the first gesture pattern information to form the switch-type deformable manipulation part S1.

Referring to FIG. 4C, when recognizing the first gesture pattern information, the controller 120 may protrude any region of a surface of the touch display 110 depending on settings to form the switch-type deformable manipulation parts S1.1 to S1.9. In other words, it is possible to randomly select locations where switch-type deformable manipulation parts are formed, the number of the switch-type deformable manipulation parts, and forms of the switch-type deformable manipulation parts depending on a user setting.

In other words, the switch-type deformable manipulation part may be formed on a surface region of the touch display 110, corresponding to touch coordinates of a user input, but there is no need to form the switch-type deformable manipulation part on the surface region of the touch display 110, corresponding to the touch coordinates of the user input.

Functions of the switch-type deformable manipulation parts S1 and S1.1 to S1.9 may be varied according to a user setting. Typically, the switch-type deformable manipulation parts S1 and S1.1 to S1.9 may be used as on/off manipulation buttons or the like of a device in the vehicle, but are not necessarily limited to such functions.

It is possible for the user to randomly set a height, a size, an interval, a function, and the like of each of the switch-type deformable manipulation parts S1 and S1.1 to S1.9. The switch-type deformable manipulation parts S1 and S1.1 to S1.9 set as an embodiment may be used as a power switch and the like of a navigation device for vehicle.

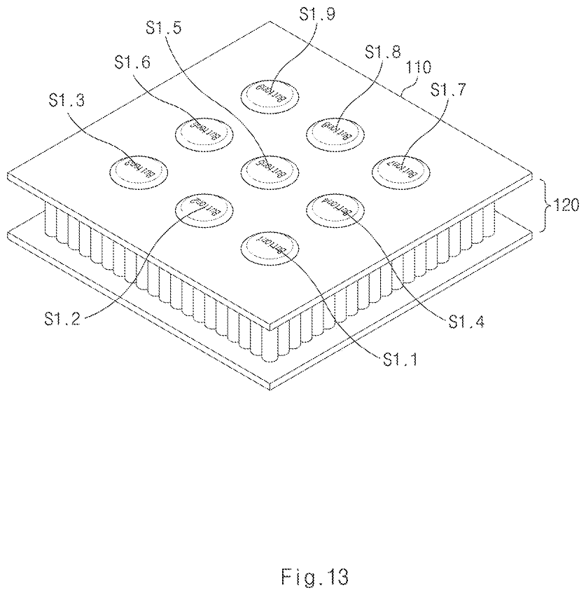

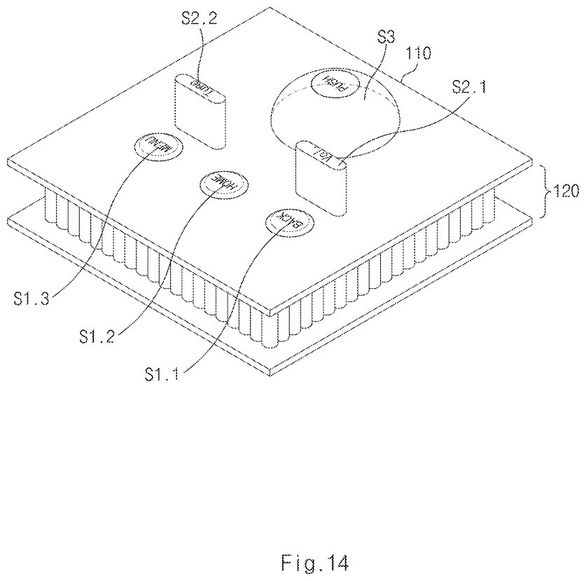

As the switch-type deformable manipulation parts S1 and S1.1 to S1.9 are formed, the user may use the input device 100 as an input device for a predetermined function. As the deformable manipulation part is formed, the controller 120 may output a separate graphic user interface on the touch display 110 to assist the user to use the input device. A detailed embodiment thereof will be described with reference to FIGS. 13 and 14.

After the switch-type deformable manipulation parts S1 and S1.1 to S1.9 are protruded, when a touch input on an upper region of the protruded region is recognized, a predetermined function may be executed. In other words, the user may use the input device 100 as an input device which executes the predetermined function depending on the touch input on the upper region of the protruded region.

FIGS. 5A to 5C are drawings illustrating a process where a controller 120 forms rod-type deformable manipulation parts S2 and S2.1 to S2.4 according to an embodiment of the present disclosure. The rod-type deformable manipulation parts S2 and S2.1 to S2.4 may be formed as, when there is a scroll user input on a touch display 110, touch coordinates of which are continuous, and when a length of the scroll user input corresponds to a set length, the controller 120 recognizes gesture pattern information according to the user input as second gesture pattern information.

The length of the scroll user input for recognizing the second gesture pattern information may be randomly set by a user. When the set length is a length of a setting value or more or is a length within a certain error range for the setting value without necessarily referring to only a specific value, it may be configured to recognize the gesture pattern information according to the user input as the second pattern information.

In FIGS. 5A and 5B, an embodiment in which, when the touch coordinates are continuous and when the length of the user input is the set length (a length corresponding to four touch coordinates in FIG. 5A), the controller 120 recognizes the gesture pattern information corresponding to the user input as the second gesture pattern information is shown. Gesture pattern information G2 corresponding to the second gesture pattern information, exemplified in FIG. 5A, may have the length corresponding to the four touch coordinates on the drawing, but may have any length depending to a user setting.

Referring to FIG. 5B, the controller 120 may protrude a region of the touch display 110 at a location corresponding to a straight line where initial touch coordinates of the user input are a start point and where final touch coordinates of the user input are an end point using the second gesture pattern information to form the rod-type deformable manipulation part S2.

Referring to FIG. 5C, when receiving the second gesture pattern information, the controller 120 may protrude any region of a surface of the touch display 110 depending on settings to form the rod-type deformable manipulation parts S2.1 to S2.4. In other words, it is possible to randomly select locations where rod-type deformable manipulation parts are formed, the number of the rod-type deformable manipulation parts, and forms of the rod-type deformable manipulation parts depending on a user setting.

The rod-type deformable manipulation parts may be formed by protruding the surface region of the touch display 110, corresponding to the straight line where the initial touch coordinates of the user input are the start point and where the final touch coordinates are the end point, but there is no need to form the rod-type deformable manipulation parts on the surface region of the touch display 110, corresponding to the touch coordinates of the user input.

Like the rod-type deformable manipulation part S2.4 of FIG. 5C, the rod-type deformable manipulation part may be set in a bent form, and a side portion of the rod-type deformable manipulation part may be a target to be input.

Functions of the rod-type deformable manipulation parts S and S2.1 to S2.4 may be varied according to a user setting. Typically, the rod-type deformable manipulation parts S and S2.1 to S2.4 may be used to manipulate an output and frequency of a device in the vehicle, but are not necessarily limited to such functions.

It is possible for a user to randomly set a size, a height, an angle, a protruded degree, an arrangement interval, and a function of each of the rod-type deformable manipulation parts S and S2.1 to S2.4. The rod-type deformable manipulation parts S and S2.1 to S2.4 set as an embodiment may be used as a volume adjustment input device of a speaker in the vehicle, a temperature adjustment input device of an air conditioner for vehicle, and the like.

As the rod-type deformable manipulation parts S and S2.1 to S2.4 are formed, the user may use the input device 100 as an input device for a predetermined function. As the rod-type deformable manipulation parts are formed, the controller 120 may output a separate graphic user interface on the touch display 110 to assist the user to use the input device 110. A detailed embodiment thereof will be described in detail with reference to FIG. 14.

After the rod-type deformable manipulation parts S2 and S2.1 to S2.4 are protruded, when a touch input on an upper or side region of the protruded region is recognized, a predetermined function may be executed. In other words, the user may use the input device 100 as an input device which executes the predetermined function depending on the touch input on the upper and side region of the protruded region.

The upper region and the side region of the rod-type deformable manipulation parts S2 and S2.1 to S2.4 may be configured to perform different functions or the same function.

FIGS. 6A to 6C are drawings illustrating a process forming circular deformable manipulation parts S3 and S3.1 to S3.4 according to an embodiment of the present disclosure. The circular deformable manipulation parts S3 and S3.1 to S3.4 may be formed as, when there is a swiping user input on a touch display 110, touch coordinates of which include all or a portion of a set closed curve, and when a length of the swiping user input corresponds to a set length, a controller 120 recognizes gesture pattern information according to the swiping user input as third gesture pattern information.

Whether the length of the swiping user input for recognizing the third gesture pattern information corresponds to the set length may be randomly set by a user. In this case, whether an absolute value of the length of the swiping user input corresponds to a specific length, is greater than or equal to the specific length, or is within a certain error range for the specific length may be set as a condition for recognizing the third gesture pattern information.

In addition, whether the ratio of the length of the swiping user input to a length of the predetermined closed curve corresponds to a certain ratio may be set as a condition for recognizing the third gesture pattern information.

In FIGS. 6A and 6B, an embodiment in which, when there is the swiping user input, the touch coordinates of which include the portion or all of the set closed curve, and when the length of the swiping user input corresponds to the set length, the controller 120 recognizes the gesture pattern information according to the user input as the third gesture pattern information is shown. Gesture pattern information G3 corresponding to the third gesture pattern information, exemplified in FIG. 6A, may have the same circle as a touch coordinate trajectory of the gesture pattern information G3 as the set closed curve and may have a length thereof as the set length. However, any closed curve may be set according to a user setting, and the set length may be randomly selected.

For example, the set closed curve may be an oval or the like and is not limited in form. For the set length, a trajectory corresponding to any rate of the entire trajectory in the touch coordinate trajectory of the gesture pattern information G3 may be the set length.

Referring to FIG. 6B, the controller 120 may protrude a region of the touch display 100 at a location corresponding to all or a portion of a closed curve including from initial touch coordinates to final touch coordinates, which are recognized from a user input, using the third gesture pattern information to form the circular deformable manipulation part S3.

Referring to FIG. 6C, when recognizing the third gesture pattern information, the controller 120 may protrude any region of a surface of the touch display 110 depending on settings to form hemispherical deformable manipulation parts S3 and S3.1 to S3.4. In other words, it is possible to randomly select locations where circular deformable manipulation parts are formed, the number of the circular deformable manipulation parts, and forms of the circular deformable manipulation parts depending on a user setting.

In other words, the circular deformable manipulation parts may be formed by protruding the surface region of the touch display 110, corresponding to all or the portion of the closed curve including from the initial touch coordinates of the user input to the final touch coordinates. However, there is no need to form the circular deformable manipulation parts on the surface region of the touch display 110 at a location corresponding to touch coordinates of the user input and the inside of a closed curve connecting the touch coordinates.

As shown in FIG. 6C, the circular deformable manipulation parts may be in various forms such as a hemispherical shape, a cylindrical shape, and the like. Locations where the circular deformable manipulation parts are formed may be freely set according to a user setting.

Functions of the circular deformable manipulation parts S3 and S3.1 to S3.4 may be varied according to a user setting. Typically, the circular deformable manipulation parts S3 and S3.1 to S3.4 may be used as a device which turns on/off an audio, video, navigation (AVN) device in the vehicle or selects desired content in a specific list, but are not necessarily limited to such functions.

It is possible for the user to randomly set a height, a size, an arrangement interval, and a function of each of the circular deformable manipulation parts S3 and S3.1 to S3.4. When the user turns and manipulates the periphery of the circular deformable manipulation part S3, the circular deformable manipulation part S3 set as an embodiment may perform a ‘wheel function’ through the touch display 110. When the user touches a protruded upper end of the circular deformable manipulation part S3, the circular deformable manipulation part S3 may perform a ‘selection switch function’. A manipulation device of a radio for vehicle or the like may be provided as an example of using the circular deformable manipulation part.

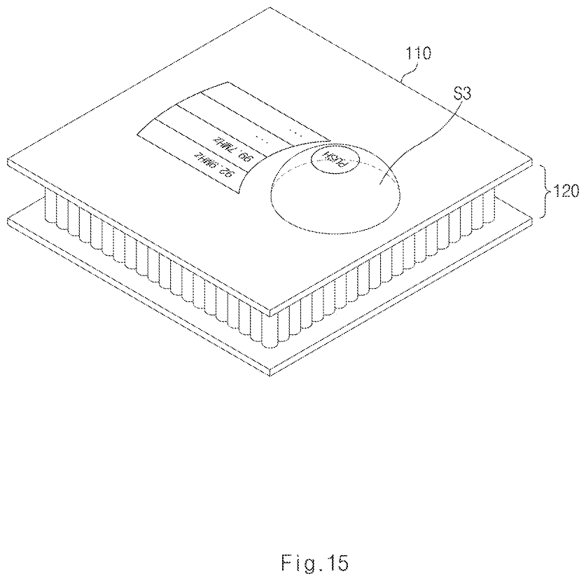

As the circular deformable manipulation parts S3 and S3.1 to S3.4 are formed, the user may use the input device 100 as an input device for a predetermined function. As the circular deformable manipulation parts are formed, the controller 120 may output a separate graphic user interface on the touch display 110 to assist the user to use the input device 110. A detailed embodiment thereof will be described in detail with reference to FIGS. 14 and 15.

After the circular deformable manipulation parts S3 and S3.1 to S3.4 are protruded, when a touch input on an upper or side region of the protruded region is recognized, a predetermined function may be executed. In other words, the user may use the input device 100 as an input device which executes the predetermined function depending on the touch input on the upper and side region of the protruded region.

The upper region and the side region of each of the circular deformable manipulation parts S3 and S3.1 to S3.4 may be configured to perform different functions or the same function.

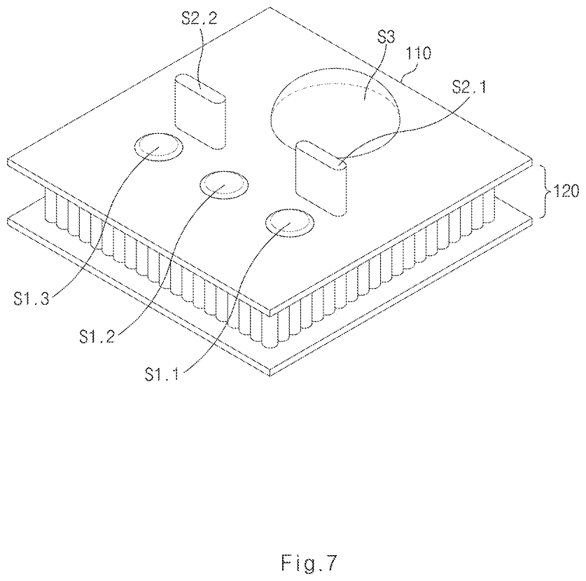

FIG. 7 is a perspective view illustrating an embodiment of forming a deformable manipulation part of an input device according to an embodiment of the present disclosure.

Referring to FIG. 7, deformable manipulation parts formed on the input device according to an embodiment of the present disclosure may include all of switch-type deformable manipulation parts S1.1 to S1.3, rod-type deformable manipulation parts S2.1 and S2.2, and a circular deformable manipulation part S3.

It is possible to set to form the deformable manipulation parts shown in FIG. 7 by recognizing specific gesture patter information among first to third gesture pattern information. The deformable manipulation part capable of being formed on the input device according to an embodiment of the present disclosure is not limited in form to the embodiment.

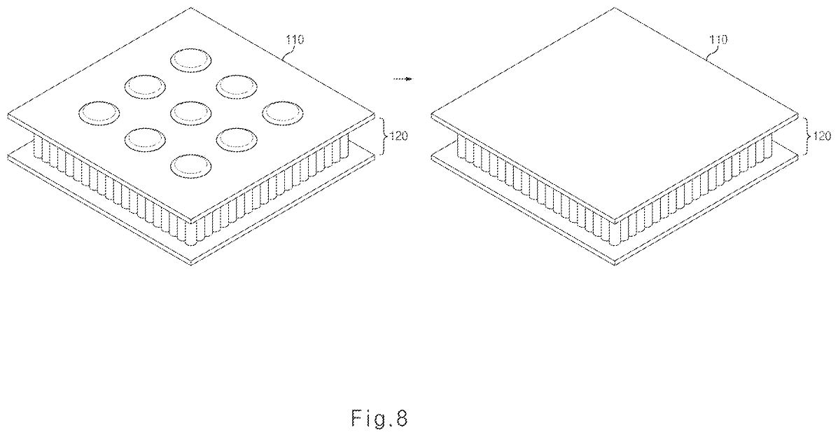

FIG. 8 is a perspective view illustrating an embodiment of releasing a formed deformable manipulation part to return to an original state, when there is no user input during a set time, in an operation method of an input device according to an embodiment of the present disclosure.

When there is no user input during a set time after a deformable manipulation part is formed or when a gesture set to a gesture of disabling the deformable manipulation part is input, an input device 100 according to an embodiment of the present disclosure may perform a function of disabling the deformable manipulation part and returning a touch display 110 to an original state under control of a controller 120.

The set time may be randomly selected by a user. For example, when there is no user input over a time set by the user, the controller 120 may control the formed deformable manipulation part to be released.

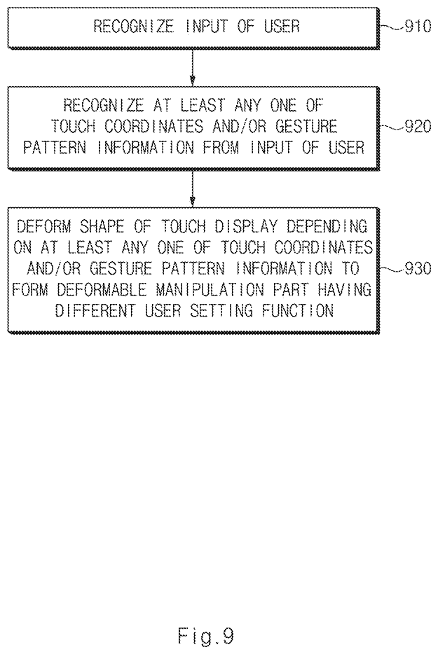

FIG. 9 is a flowchart illustrating an operation method of an input device according to an embodiment of the present disclosure.

Referring to FIG. 9, the operation method of the input device according to an embodiment of the present disclosure may include operation 910 of recognizing an input of a user, operation 920 of recognizing at least any one of touch coordinates and/or gesture pattern information from the input of the user, and operation 930 of deforming a shape of a touch display 110 depending on the gesture pattern information to form a deformable manipulation part having a different user setting function.

The gesture pattern information may refer to a pattern program obtained as a controller 120 of FIG. 1 analyzes an input of the user on a touch display 110 of FIG. 1 and recognizes whether the input corresponds to any predetermined pattern based on the analyzed result. In other words, the gesture pattern information may refer to a shape of a user input on the touch display 110.

The gesture pattern information may include a touch gesture used for a general touch input device. For example, the input device according to an embodiment of the present disclosure may recognize gesture pattern information including any one of a ‘touch user input’ which refers to a discrete input, a ‘scroll user input’ which refers to a continuous input, and a ‘swiping user input’ in which a continuous input includes a portion or all of a closed curve. Hereinafter, operations 910 to 930 will be described with reference to FIG. 1.

Operation 910, the touch display 110 may recognize the input of the user. The controller 120 may recognize at least any one of the touch coordinates and/or the gesture pattern information from the input of the user. The controller 120 may recognize the gesture pattern information as first gesture pattern information, second gesture pattern information, and third gesture pattern information depending on at least any one of the touch coordinates and/or the gesture pattern information.

Furthermore, the gesture pattern information may further include at least any one of the number of touches and/or touch time information.

When there is a touch user input, touch coordinates of which are discrete, and when the number of touches in the touch user input corresponds to a set number, the controller 120 may recognize the gesture pattern information as the first gesture pattern information. When there is a scroll user input, touch coordinates of which are continuous, and when a length of the scroll user input corresponds to a set length, the controller 120 may recognize the gesture pattern information as the second gesture pattern information. When there is a swiping user input, touch coordinates of which include a portion or all of a set closed curve, and when a length of the swiping user input corresponds to a set length, the controller 120 may recognize the gesture pattern information as the third gesture pattern information.

Each of the first gesture pattern information, the second gesture pattern information, and the third gesture pattern information may further include at least any one of the number of touches and/or touch time information.

In operation 920, the controller 120 may recognize the gesture pattern information based on the user input on the touch display 110.

In operation 930, the controller 120 may control the touch display 110 depending on the recognized gesture pattern information. For example, the controller 120 may deform a shape of the touch display 110 depending on the first to third gesture pattern information to form a deformable manipulation part which has a different user setting function depending on touch information. For example, the controller 120 may control a vertical movement of a deformable member located inside or outside the touch display 110 depending on the gesture pattern information to form a deformable manipulation part.

When recognizing the first gesture pattern information, the controller 120 may protrude a surface region of the touch display 110 depending on settings to form a switch-type deformable manipulation part on a surface of the touch display 110. When recognizing the second gesture pattern information, the controller 120 may protrude a surface region of the touch display 110 depending on settings to form a rod-type deformable manipulation part on a surface of the touch display 110.

When recognizing the third gesture pattern information, the controller 120 may protrude a surface region of the touch display 110 to form a circular deformable manipulation part on a surface of the touch display 110.

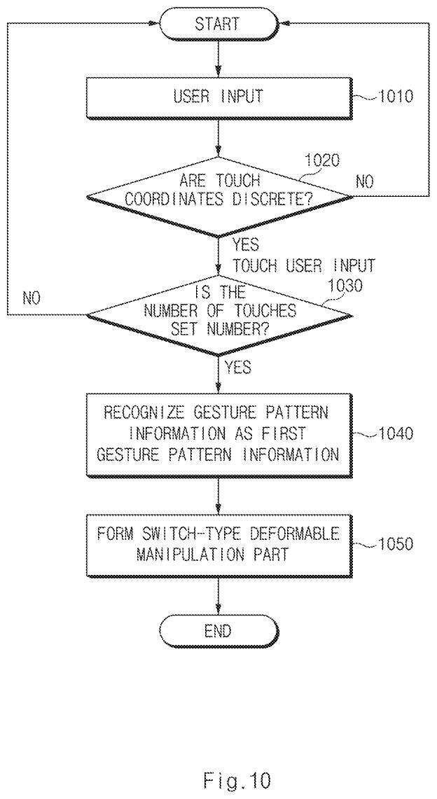

FIG. 10 is a flowchart illustrating a process for recognizing first gesture pattern information in an operation method of an input device according to an embodiment of the present disclosure.

Referring to FIG. 10, in the operation method according to an embodiment of the present disclosure, operations 920 and 930 of FIG. 9 will be described in detail.

Hereinafter, operations 1010 to 1050 will be described with reference to FIGS. 4A to 4C.

A controller 120 of FIG. 1 may recognize touch information from a user input. Operation 920 of recognizing gesture pattern information starts from operation 1010 of recognizing the user input on a touch display 110. When there is the user input, the controller 120 may proceed to operation 1020 of determining whether touch coordinates are discrete.

In operation 1020, the controller 120 may determine whether gesture pattern information according to the user input is first gesture pattern information, depending on whether the touch coordinates are discrete. When the touch coordinates of the user input are not discrete, the controller 120 may initiate determination again when there is a new user input. When the touch coordinates of the user input are discrete, the controller 120 may recognize the user input as a touch user input. Thereafter, the controller 120 may proceed to operation 1030 of determining whether the number of touches is a set number.

In operation 1030, when the touch coordinates are discrete and when the number of touches is the set number, the controller 120 may proceed to operation 1040 of recognizing gesture pattern information according to the user input as first gesture pattern information including touch coordinates and the number of touches.

Furthermore, the first gesture pattern information may further include touch time information.

When recognizing the gesture pattern information according to the user input as the first gesture pattern information, in operation 1050, the controller 120 may protrude a region corresponding to a location set on a surface of the touch display 110 to form a switch-type deformable manipulation part.

As shown in FIG. 4B, the switch-type deformable manipulation part may be formed by protruding a region corresponding to a location of touched respective coordinates.

Furthermore, as shown in FIG. 4C, locations where the switch-type deformable manipulation parts are formed and forms of the switch-type deformable manipulation parts may be determined according to a user setting.

When the switch-type deformable manipulation part is formed and when a touch input on an upper region of the protruded region is recognized, a predetermined function may be executed.

As described above, the predetermined function may be an on/off manipulation button or the like of a device in the vehicle, but is not necessarily limited to such a function.

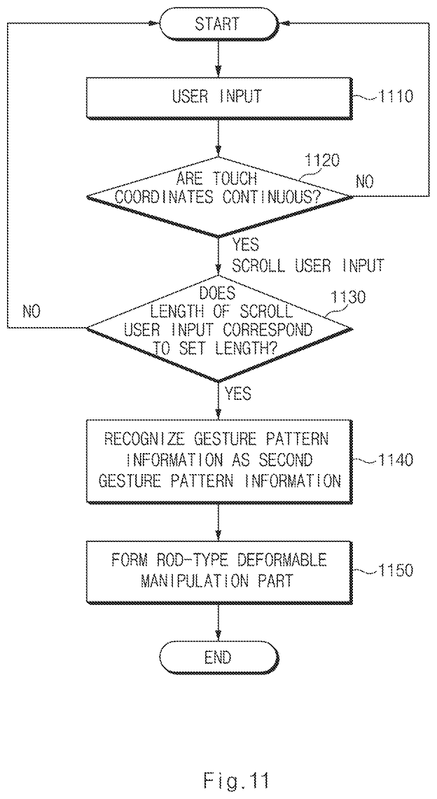

FIG. 11 is a flowchart illustrating a process for recognizing second gesture pattern information in an operation method of an input device according to an embodiment of the present disclosure.

Referring to FIG. 11, in the operation method according to an embodiment of the present disclosure, operations 920 and 930 of FIG. 9 will be described in detail.

Hereinafter, operations 1110 to 1150 will be described with reference to FIG. 5A to FIG. 5C.

A controller 120 of FIG. 1 may recognize touch information from a user input. Operation 920 of recognizing gesture pattern information starts operation 1110 of recognizing the user input on a touch display 110 of FIG. 1. When there is the user input, the controller 120 may proceed to operation 1120 of determining whether touch coordinates are continuous.

In operation 1120, the controller 120 may determine whether gesture pattern information according to the user input is second gesture pattern information, depending on whether the touch coordinates are continuous. When the touch coordinates of the user input are not continuous, the controller 120 may initiate determination again when there is a new user input. When the touch coordinates of the user input are continuous, the controller 120 may recognize the user input as a scroll user input. Thereafter, the controller 120 may proceed to operation 1130 of determining whether a length of the scroll user input corresponds to a set length.

In operation 1130, when the touch coordinates are continuous and when the length of the scroll user input corresponds to the set length, the controller 120 may proceed to operation 1140 of recognizing the gesture pattern information according to the user input as the second gesture pattern information including touch coordinates and the number of touches.

Furthermore, the second gesture pattern information may further include touch time information.

When recognizing the gesture pattern information according to the user input as the second gesture pattern information, in operation 1150, the controller 120 may protrude a region corresponding to a location set on a surface of the touch display 110 to form a rod-type deformable manipulation part.

As shown in FIG. 5B, the rod-type deformable manipulation part may be formed by protruding a region corresponding to a straight line where initial touch coordinates of the user input are a start point and where final touch coordinates of the touch input are an end point.

Furthermore, as shown in FIG. 5C, locations where the rod-type deformable manipulation parts are formed and forms of the rod-type deformable manipulation parts may be determined according to a user setting.

When the rod-type deformable manipulation part is formed and when a touch input on an upper or side region of the protruded region is recognized, a predetermined function may be executed.

As described above, the predetermined function may be a function of manipulating an output and frequency of a device in the vehicle, but is not necessarily limited to such a function.

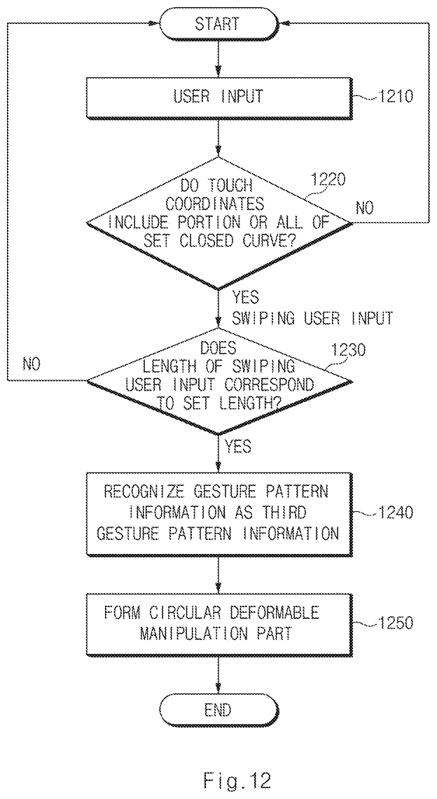

FIG. 12 is a flowchart illustrating a process for recognizing third gesture pattern information in an operation method of an input device according to an embodiment of the present disclosure.

Referring to FIG. 12, in the operation method according to an embodiment of the present disclosure, operations 920 and 930 of FIG. 9 will be described in detail.

Hereinafter, operations 1210 to 1250 will be described with reference to FIGS. 6A to 6C.

A controller 120 of FIG. 1 may recognize touch information from a user input. Operation 920 of recognizing gesture pattern information starts to operation 1210 of recognizing the user input on a touch display 110 of FIG. 1. When there is the user input, the controller 120 may proceed to operation 1220 of determining whether touch coordinates include a portion or all of a set closed curve.

In operation 1220, the controller 120 may determine whether gesture pattern information according to the user input is third gesture pattern information, depending on whether the touch coordinates include the portion or all of the set closed curve. When the touch coordinates of the user input do not include the portion or all of the set closed curve, the controller 120 may initiate determination again when there is a new user input. When the touch coordinates of the user input include the portion or all of the set closed curve, the controller 120 may recognize the user input as a swiping user input. Thereafter, the controller 120 may proceed to operation 1230 of determining whether a length of the swiping user input corresponds to a set length.

In operation 1230, when the touch coordinates include the portion or all of the set closed curve and when the length of the swiping user input corresponds to the set length, the controller 120 may proceed to operation 1240 of recognizing the gesture pattern information according to the user input as the third gesture pattern information including touch coordinates and the number of touches.

Furthermore, the third gesture pattern information may further include touch time information.

When recognizing the gesture pattern information according to the user input as the third gesture pattern information, in operation 1250, the controller 120 may protrude a region corresponding to a location set on a surface of the touch display 110 to form a circular deformable manipulation part.

As shown in FIG. 6B, the circular deformable manipulation part may be formed by protruding a region corresponding to all or a portion of a closed curve including from initial touch coordinates of the user input to final touch coordinates of the user input.

Furthermore, as shown in FIG. 6C, locations where the circular deformable manipulation parts are formed and forms of the circular deformable manipulation parts may be determined according to a user setting.

When the circular deformable manipulation part is formed and when a touch input on an upper or side region of the protruded region is recognized, a predetermined function may be executed.

As described above, the predetermined function may be a function of turning on/off an AVN device in the vehicle or selecting desired content in a specific list, but is not necessarily limited to such a function.

FIG. 13 is a drawing illustrating graphic user interfaces of switch-type deformable manipulation parts S1.1 to S1.9 according to an embodiment of the present disclosure.

Referring to FIG. 13, as switch-type deformable manipulation parts S1.1 to S1.9 are formed, a controller 120 may output graphic user interfaces on a touch display 110. As an embodiment, the controller 120 may output button shortcut keys Button 1 to Button 9 as graphic user interfaces for the switch-type deformable manipulation parts S1.1 to S1.9. The graphic user interfaces may improve convenience of manipulation of a user and may assist in manipulation of the switch-type deformable manipulation parts S1.1 to S1.9.

FIG. 14 is a drawing illustrating graphic user interfaces of switch-type deformable manipulation parts S1.1 to S1.3, rod-type deformable manipulation parts S2.1 and S2.2, and a circular deformable manipulation part S3 according to an embodiment of the present disclosure.

Referring to FIG. 14, as the switch-type deformable manipulation parts S1.1 to S1.3 are formed, a controller 120 may output graphic user interfaces on a touch display 110. As an embodiment, the controller 120 may output back button BACK, home button HOME, and menu button MENU as graphic user interfaces for the switch-type deformable manipulation parts S1.1 to S1.3. The graphic user interfaces may improve convenience of manipulation of a user and may assist in manipulation of the switch-type deformable manipulation parts S1.1 to S1.3.

Although not illustrated in the drawing, when the switch-type deformable manipulation parts S1.1 to S1.3 are formed, graphic user interfaces, such as a ‘hot key’, a ‘favorite’, or a ‘setting function key with a high frequency of use’ according to a user setting other than button shortcut keys, back button BACK, home button HOME, and menu button MENU, may be output on the touch display 110 by the controller 120.

Referring to FIG. 14, as the rod-type deformable manipulation parts S2.1 and S2.2 are formed, the controller 120 may output graphic user interfaces on the touch display 110. As an embodiment, the controller 120 may output volume manipulation key Vol. and frequency manipulation key Tune as graphic user interfaces for the rod-type deformable manipulation parts S2.1 and S2.2. The graphic user interfaces may improve convenience of manipulation of a user and may assist in manipulation of the rod-type deformable manipulation parts S2.1 and S2.2.

Although not illustrated in the drawing, as the rod-type deformable manipulation parts S2.1 and S2.2 are formed, a graphic user interface having a scroll, slide function suitable for manipulating a side of a rod-type deformable manipulation part other than volume manipulation key Vol. and frequency manipulation key Tune may be output on the touch display 110 by the controller 110.

Referring to FIG. 14, as the circular deformable manipulation part S3 is formed, the controller 120 may output a graphic user interface on the touch display 110. As an embodiment, selection button PUSH may be output on an upper end of the circular deformable manipulation part S3 as a graphic user interface for the circular deformable manipulation part S3.

FIG. 15 is a drawing illustrating a graphic user interface as a circular deformable manipulation part S3 is formed according to an embodiment of the present disclosure.

Referring to FIG. 15, as the circular deformable manipulation part S3 is formed, a controller 120 may output a graphic user interface on a touch display 110. As an embodiment, the controller 120 may output a manipulation screen or the like, for selecting a frequency of a radio for vehicle, as a graphic user interface for the circular deformable manipulation part S3. The graphic user interface may improve convenience of manipulation of a user and may assist in manipulation of the circular deformable manipulation part S3.

Although not illustrated in the drawing, as an embodiment, the controller 120 may output an audio track list, a selection button, and the like of the vehicle as a graphic user interface for the circular deformable manipulation part S3. The graphic user interface may improve convenience of manipulation of a user and may assist in manipulation of the circular deformable manipulation part S3.

When the circular deformable manipulation part S3 is formed, a graphic user interface suitable for scroll-type manipulation may be output on an outer portion of a hemispherical deformable manipulation part on the touch display 110 by the controller 120, and a graphic user interface suitable for selection function manipulation may be output on a central portion of the hemispherical deformable manipulation part on the touch display 110 by the controller 120, other than the frequency selection screen and the selection button PUSH.

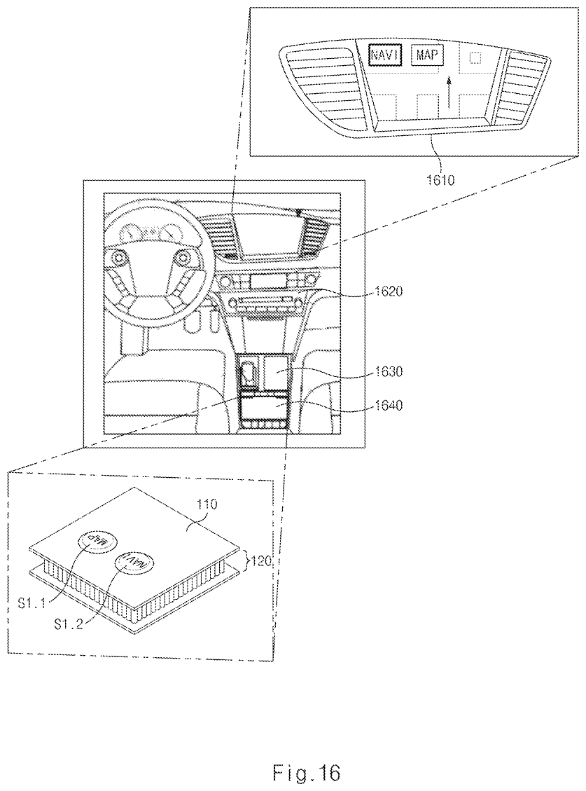

FIG. 16 is a drawing illustrating an operation of a user setting function of a deformable manipulation part according to an embodiment of the present disclosure and a location when an input device according to an embodiment of the present disclosure is applied to a vehicle.

Referring to FIG. 16, the input device according to an embodiment of the present disclosure may be located in an air conditioner manipulation part 1620 for vehicle, a space 1630 between the driver's seat and the front passenger seat, a gearbox space 1640, or the like.

As an embodiment in FIG. 16, when the input device according to an embodiment of the present disclosure is located in the gearbox space 1640 and when switch-type deformable manipulation parts S1.1 and S1.2 are formed, it is shown that a navigation image may be output on a screen 1610 of an AVN device of the vehicle.

A user may manipulate a deformable manipulation part formed on the input device according to an embodiment of the present disclosure to manipulate a navigation or map screen or the like. As the deformable manipulation part is formed, convenience of manipulation may be increased while driving to create a more pleasant, efficient driving environment.

The features, structures, effects, and the like exemplified in the description of the deformable manipulation part are included in an embodiment of the present disclosure. A function of the input device according to an embodiment of the present disclosure is not necessarily limited to such an embodiment. In addition, it is possible for the features, structures, effects, and the like represented in such an example to be combined or modified and be executed by those skilled in the art to which the present disclosure pertains. Thus, when executed based on such combination and modification, it should be interpreted that the features, structures, effects, and the like are included in the scope of the present disclosure.

Furthermore, the description is given above of the switch-type, rod-type, and circular deformable manipulation parts, but this is merely illustrative. The present disclosure is not limited to only the three types of deformable manipulation parts. Those skilled in the art to which the present disclosure pertains may make several modifications and applications which are not exemplified, without depart from the scope of the essential characteristics of the embodiment.

In addition, the user input for forming the deformable manipulation part is not necessarily limited to the embodiment. As an embodiment, a manner which inputs gesture touch information having touch coordinates and the number of touches corresponding to any form to the input device may be proposed. In this case, it is exemplified that a deformable manipulation part similar to the rod-type deformable manipulation part is formed by protruding a surface of a touch display, corresponding to touch coordinates of any input gesture touch information. Similarly, another manipulation mode may be enabled based on input information different from the embodiment.

In other words, because it is possible for respective components represented in detail in the embodiment to be modified and executed, it should be interpreted that differences associated with such modifications and applications are included in the spirit and scope of the prevent disclosure defined in the accompanying claims.

The present technology may recognize at least any one of touch coordinates and/or gesture pattern information depending on an input of the user and may provide a deformable manipulation part, a shape of which is changed, thus improving convenience of manipulation of the user and allowing the user to perform accurate manipulation in a situation where he or she is unable to visually view a manipulator.

Furthermore, the present technology may provide deformable manipulation parts of different shapes depending on gesture pattern information to perform a predetermined function depending on a changed shape, thus providing a sense of physical manipulation incapable of being provided by a two-dimensional display to the user. The deformable manipulation part included in the input device of the present technology may be formed in the form of a switch, a rod, a circle (wheel), or the like, thus implementing a manipulation scheme incapable of being implemented by a simple two-dimensional input device.

In addition, various effects directly or indirectly ascertained through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

1. An input device, comprising:
a touch display configured to recognize an input of a user; and
a controller configured to recognize at least any one of touch coordinates and/or gesture pattern information from the input of the user and deform a shape of the touch display depending on the at least any one of the touch coordinates and the gesture pattern information to form a deformable manipulation part having a different user setting function.

2. The input device of claim 1, wherein the controller controls a vertical movement of a deformable member located inside or outside the touch display to form the deformable manipulation part.

3. The input device of claim 1, wherein the controller recognizes the gesture pattern information as first gesture pattern information, when there is a touch user input, the touch coordinates of which are discrete, and when the number of touches in the touch user input corresponds to a set number.

4. The input device of claim 3, wherein the controller protrudes a region corresponding to a location set on a surface of the touch display or a location of touched respective coordinates to form a switch-type deformable manipulation part on the surface of the touch display, when recognizing the first gesture pattern information.

5. The input device of claim 4, wherein the controller executes a predetermined function, when a touch input on an upper region of the protruded region is recognized after the region is protruded.

6. The input device of claim 1, wherein the controller recognizes the gesture pattern information as second gesture pattern information, when there is a scroll user input, the touch coordinates of which are continuous, and when a length of the scroll user input corresponds to a set length.

7. The input device of claim 6, wherein the controller protrudes a region corresponding to a location set on a surface of the touch display or corresponding to a straight line where initial touch coordinates are a start point and where final touch coordinates are an end point to form a rod-type deformable manipulation part on the surface of the touch display, when recognizing the second gesture pattern information.

8. The input device of claim 7, wherein the controller executes a predetermined function, when a touch input on an upper or side region of the protruded region is recognized after the region is protruded.

9. The input device of claim 1, wherein the controller recognizes the gesture pattern information as third gesture pattern information, when there is a swiping user input, the touch coordinates of which include a portion or all of a set closed curve, and when a length of the swiping user input corresponds to a set length.

10. The input device of claim 9, wherein the controller protrudes a region corresponding to a location set on a surface of the touch display or corresponding to all or a portion of a closed curve including from initial touch coordinates to final touch coordinates to form a circular deformable manipulation part on the surface of the touch display, when recognizing the third gesture pattern information.

11. The input device of claim 10, wherein the controller executes a predetermined function, when a touch input on an upper or side region of the protruded region is recognized after the region is protruded.

12. The input device of claim 1, wherein the controller implements a graphic user interface (GUI) according to a form of the deformable manipulation part on the touch display.

13. The input device of claim 1, wherein the controller releases the formed deformable manipulation part to return to an original state, when there is no user input on the touch display during a set time.

14. An operation method of an input device, the method comprising:
recognizing an input of a user;
recognizing at least any one of touch coordinates and/or gesture pattern information from the input of the user; and
deforming a shape of a touch display depending on the at least any one of the touch coordinates and/or the gesture pattern information to form a deformable manipulation part having a different user setting function.

15. The method of claim 14, wherein the forming of the deformable manipulation part includes:
controlling a vertical movement of a deformable member located inside or outside the touch display to form the deformable manipulation part.

16. The method of claim 14, wherein the recognizing of the at least any one of the touch coordinates and/or the gesture pattern information includes:
recognizing the gesture pattern information as first gesture pattern information, when there is a touch user input, the touch coordinates of which are discrete, and when the number of touches in the touch user input corresponds to a set number.

17. The method of claim 16, wherein the forming of the deformable manipulation part includes:
protruding a region corresponding to a location set on a surface of the touch display or a location of touched respective coordinates to form a switch-type deformable manipulation part on the surface of the touch display, when recognizing the first gesture pattern information.

18. The method of claim 14, wherein the recognizing of the at least any one of the touch coordinates and/or the gesture pattern information includes:
recognizing the gesture pattern information as second gesture pattern information, when there is a scroll user input, the touch coordinates of which are continuous, and when a length of the scroll user input corresponds to a set length.

19. The method of claim 18, wherein the forming of the deformable manipulation part includes:
protruding a region corresponding to a location set on a surface of the touch display or corresponding to a straight line where initial touch coordinates are a start point and where final touch coordinates are an end point to form a rod-type deformable manipulation part on the surface of the touch display, when recognizing the second gesture pattern information.

20. The method of claim 14, wherein the recognizing of the at least any one of the touch coordinates and/or the gesture pattern information includes:
recognizing the gesture pattern information as third gesture pattern information, when there is a swiping user input, the touch coordinates of which include a portion or all of a set closed curve, and when a length of the swiping user input corresponds to a set length.

21. The method of claim 20, wherein the forming of the deformable manipulation part includes:
protruding a region corresponding to a location set on a surface of the touch display or corresponding to all or a portion of a closed curve including from initial touch coordinates to final touch coordinates to form a circular deformable manipulation part on the surface of the touch display, when recognizing the third gesture pattern information.

22. The method of claim 14, further comprising:
implementing a graphic user interface (GUI) on the touch display depending on a form of the deformable manipulation part.

23. The method of claim 14, further comprising:
releasing the formed deformable manipulation part to return to an original state, when there is no user input on the touch display during a set time.
